(19) United States
(12) Patent Application Publication
(10) Pub. No.: US 2022/0384846 A1
(43) Pub. Date: Dec. 1, 2022

(54) Flexible and stable 3D Zn electrode for high-power density Zn metal batteries

(71) Applicant: Massachusetts Institute of Technology, Cambridge, MA (US)

(72) Inventors: Yunguang Zhu, Cambridge, MA (US); Yang Shao-Horn, Newton, MA (US)

(73) Assignee: Massachusetts Institute of Technology, Cambridge, MA (US)

(21) Appl. No.: 17/750,274

(22) Filed: May 20, 2022

Related U.S. Application Data
(60) Provisional application No. 63/191,868, filed on May 21, 2021.

(51) Int. Cl. H01M 10/0565; H01M 4/134; H01M 4/62

(52) U.S. Cl. CPC H01M 10/0565; H01M 4/134; H01M 4/625; H01M 4/623; H01M 2300/0085

(57) ABSTRACT

A flexible Zn film electrode with ionic and electronic networks has been designed by utilizing ionic liquid based gel polymer as the binder, which can minimize the interface resistance between electrode and electrolytes. Ionic liquid electrolytes are good candidates for high surface area Zn anode due to their good electro(chemical) stability. Ionic liquid based gel polymer electrolytes (GPEs) are good candidates to replace liquid electrolytes or separators in some special applications, like surface coating structure batteries.

### PRIORITY CLAIM

This application claims priority to U.S. Application No. 63/191,868, filed Mar. 21, 2021, which is incorporated by reference in its entirety.

### FIELD OF THE INVENTION

The invention relates to compositions suitable for electrode materials for batteries.

### BACKGROUND

To meet the high mileage requirement of electric vehicles (EVs), research institutes and industries focus on developing high energy density Li-ion batteries. (ref. 1) Compared to lithium-ion batteries, rechargeable zinc metal batteries (RZMBs) using zinc (Zn) anode and non-flammable electrolytes are the promising candidates in EV applications with advantages of cost-effectiveness, good safety, and high energy density. (ref. 2) However, the high-energy Zn anode shows poor cycling stability in aqueous electrolytes due to the corrosion and the dendrite formation.(ref. 2) Several methods were reported to prevent the Zn dendrite formation, such as electrolyte modification (refs. 3-5), Zn metal modification (refs. 6-9), a novel charge-discharge scenario for Zn plating/striping. (ref. 10) For example, concentrated aqueous electrolytes (e.g., 1 M Zn(TFSI)₂+20 M LiTFSI) were recently demonstrated to improve the cycling stability of Zn metal. (ref. 5) However, the high cost of concentrated electrolytes may hinder their practical application. Some types of local-concentrated electrolytes were designed for Li-ion batteries to lower the cost (refs. 11, 12), which can also be employed for rechargeable Zn-ion batteries. Except for the liquid electrolytes, gel polymer electrolytes containing both liquids and solid polymers with high conductivity have been widely studied for Li-ion batteries (refs. 13, 14), Na-ion batteries (refs. 15, 16), and Zn-ion batteries (refs. 17-19). However, the narrow electrochemical window of aqueous electrolytes not only leads to poor cycling stability of the Zn anode but also hinders the exploration of high voltage cathodes for RZMBs. Therefore, it is very significant to explore alternative non-aqueous electrolytes for RZMBs. Among these non-aqueous electrolytes, ionic liquids attracted lots of attention due to their high thermal stability, high conductivity, wide stable window, etc., which can extend the application of RZMBs in harsh environments. (ref. 20)

Except for the electrolyte selection, the design of the Zn metal anode is also critical to develop RZMBs for flexible or structural battery applications. Zn planar metal is the most common Zn anode in RZMBs, but it limits the design flexibility. (ref. 21) In order to overcome the disadvantages of Zn planar metal electrodes, some groups developed flexible and free-standing Zn anode in Zn-air batteries using Zn particles and polymer binders. (refs. 22, 23) However, these flexible Zn anodes were applied in alkaline aqueous electrolytes, which may cause serious corrosion due to high surface area of Zn particles and usage of carbon conductive additives. (refs. 24)

### SUMMARY

In one aspect, a zinc film electrode for a battery can include an ionic liquid based gel polymer as a binder. In certain circumstances, the zinc film electrode can include an electrically conductive network.

In another aspect, a rechargeable zinc metal battery can include a Zn film electrode comprising an ionic liquid based gel polymer as a binder and an electrolyte.

In another aspect, a membrane can include a gel polymer including a fluorinated polyolefin.

In another aspect, an electrode can include a membrane including a gel polymer including a fluorinated polyolefin.

In another aspect, a battery can include an electrode can include a membrane including a gel polymer including a fluorinated polyolefin and an electrolyte.

In another aspect, a method of manufacturing an electrode can include casting a mixture of a gel polymer including a fluorinated polyolefin, an electrically conductive material, and a plurality of metal particles to form a wet film; and drying the wet film.

In certain circumstances, the electrode can include a flexible Zn film electrode.

In certain circumstances, the electrode can include a flexible three-dimensional Zn film electrode.

In certain circumstances, the electrode can include acetylene black used as an electrically conductive network.

In certain circumstances, the electrode can include an ionic liquid based gel polymer used as an ionic conductive binder.

In certain circumstances, the ionic liquid based gel polymer can include a poly(vinylidene fluoride)-co-hexafluoropropylene.

In certain circumstances, the electrolyte comprises an ionic liquid electrolyte.

In certain circumstances, the metal battery can include an electrically conductive material, a plurality of metal particles, and an ionic liquid electrolyte. In certain circumstances, the ionic liquid based gel polymer can include a poly(vinylidene fluoride)-co-hexafluoropropylene. In certain circumstances, the electrically conductive material can include acetylene black. In certain circumstances, the plurality of metal particles can include zinc. In certain circumstances, the ionic liquid electrolyte can include a sulfonate salt.

In certain circumstances, the fluorinated polyolefin can include a polyvinylidene fluoride, a polytetrafluoroethylene, a hexafluoropolypropylene, or a combination thereof. For example, the fluorinated polyolefin can include a copolymer of a polyvinylidene fluoride, a polytetrafluoroethylene, a hexafluoropolypropylene, or a combination thereof. In preferred embodiments, the fluorinated polyolefin can be poly(vinylidene fluoride)-co-hexafluoropropylene.

In certain circumstances, the membrane or electrode can include an electrically conductive material, for example, an electrically conductive network. For example, the electrically conductive material can include carbon black, carbon nanomaterials (such as carbon nanotubes or fullerenes), graphene, graphite, a conductive polymer, acetylene black, or inert metal particles. In preferred embodiments, the electrically conductive material can be acetylene black.

In certain circumstances, an electrode can include the membrane as described herein.

In certain circumstances, the electrode can include a plurality of metal particles. In preferred embodiments, the plurality of metal particles can include zinc.

In certain circumstances, the electrode can include an ionic liquid. In certain circumstances, the ionic liquid can include an imidazolium sulfonyl imide. The imidazolium sulfonyl imide can include 1-ethyl-3-methylimidazolium bis(trifluoromethylsulfonyl)imide.

In certain circumstances, a battery can include an electrode as described herein and an electrolyte. The electrolyte can include a sulfonate salt, such as a trifluoromethanesulfonate salt. For example, the electrolyte can include zinc trifluoromethanesulfonate.

For example, a stable Zn metal electrode can facilitate the development of rechargeable zinc metal batteries (RZMBs) which have the high theoretical capacity (820 mAh/g), low redox potential, and intrinsic safety. However, the corrosion of Zn metal in aqueous electrolytes and Zn dendrite formation during the plating process leads to poor cycling and thus hinders the development of RZMBs. Here, an ionic liquid-based gel polymer (poly(vinylidene fluoride)-co-hexafluoropropylene, PVDF-HFP) and acetylene black (AB) were employed to achieve a stable and flexible three-dimensional (3D) Zn/AB/PVDF-HFP film electrode with ionic and electronic conductive networks and high surface area, showing 26 times higher plating/stripping current than planar Zn plate. By developing a continuous structure between the ionic liquid-based gel polymer membrane and the flexible 3D Zn/AB/PVDF-HFP electrode, low resistance, high rate capability and long cycle life (>800 h) was obtained. A flexible Zn film electrode and ionic liquid-based gel polymer electrolyte as described herein can be used in rechargeable and high-cycle life thin-film RZMBs.

Other aspects, embodiments, and features will be apparent from the following description, the drawings, and the claims.

### BRIEF DESCRIPTION OF THE DRAWINGS

FIG. 1 depicts a schematic structure of Zn/AB/PVDF-HFP electrode and the gelation process in 0.1 M ZnTFSI₂/EMIMTFSI ionic liquid electrolyte a structure and x-ray diffraction pattern of a composition described herein.

FIGS. 2A-2F depict features of the materials described herein. FIGS. 2A-2B depict SEM images of cross-section (FIG. 2A) and the surface morphology (FIG. 2B) of a dry PVDF-HFP membrane. The scale bar is 10 μm. FIGS. 2C-2D are photos of a dry PVDF-HFP membrane (1.27 cm² of diameter) (FIG. 2C) and a swelled one (FIG. 2D). FIG. 2E is a graph depicting the Raman spectra of 0.1 M ZnTFSI₂/EMIMTFSI, the PVDF-HFP membrane, and the membrane after swelling (PVDF-HFP/EMIMTFSI+ZnTFSI₂). FIG. 2F is a graph showing the XRD patterns of the PVDF-HFP membrane and the membrane after swelling (PVDF-HFP/EMIMTFSI+ZnTFSI₂). In the gelation process, the PVDF-HFP membrane was immersed in 0.1 M ZnTFSI/EMIMTFSI ionic liquid at 50° C. for 12 h in the Ar-filled glove box. A depicts micrographs of a template synthesized composition.

FIGS. 3A-3D depict SEM images of the Zn/AB/PVDF-HFP electrode (FIGS. 3A and 3B). The inset of (FIG. 3A) shows the photo of the flexible Zn/AB/PVDF-HFP electrode. FIG. 3C is an SEM image of the cross-section of the Zn/AB/PVDF-HFP electrode. The scale bar is 5 μm. FIG. 3D is a graph showing the XRD patterns of the flexible Zn/AB/PVDF-HFP electrode (bottom) and the one after gelation (top). The standard XRD references are Zn (ICDD #04-003-7274) and ZnO (ICDD #04-023-7335).

FIGS. 4A-4F depict features of a symmetric cell. FIG. 4A depicts a Zn/AB/PVDF-HFP symmetric cell's schematic structure for electrochemical performance testing. FIG. 4B is a graph depicting a Nyquist plot is the Zn/AB/PVDF-HFP symmetric cell with a voltage bias of 10 mV with a frequency range from 1 MHz to 10 Hz. FIG. 4C is a graph depicting variation of ionic conductivity of the PVDF-HFP gel polymer electrolyte with temperature. FIG. 4D is a graph depicting cyclic voltammetry (CV) curves of Zn plating and stripping in Zn/AB/PVDF-HFP and planar Zn metal symmetric cells at a scan rate of 10 mV/s. The galvanostatic charge/discharge profiles of a Zn/AB/PVDF-HFP symmetric cell (FIG. 4E) at currents of 1, 2, 4, and 10 mA/cm²_{geo}. and a planar Zn metal symmetric cell (FIG. 4F) at currents of 0.01 and 0.02 mA/cm²_{geo}. The thickness of the Zn/AB/PVDF-HFP electrodes in the cell is ˜24 μm. The thickness of Zn plate is ˜200 μm.

FIGS. 5A-5L are SEM images and EDS mapping images of pristine (FIGS. 5A-5F) and cycled Zn/AB/PVDF-HFP electrodes (FIGS. 5G-5L). Layered images combining all four elements mapping are shown in FIGS. 5B and 5H. EDS maps of C K (FIGS. 5C and 5I), O K (FIGS. 5D and 5J), F K (FIGS. 5E and 5K) and Zn K (FIGS. 5F and 5L). The cycled Zn/AB/PVDF-HFP electrode was collected from the one after cycling for more than 800 h (FIG. 5E).

FIGS. 6A-6D are SEM images showing surface morphologies of Zn/AB/PVDF-HFP electrodes with different amounts of PVDF-HFP (9.1 w % (FIG. 6A), 13.0 w % (FIG. 6B), 16.7 w % (FIG. 6C), and 20 w % (FIG. 6D)).

FIG. 7 is a graph depicting the electrical conductivity of Zn/AB/PVDF-HFP electrodes with different amounts of PVDF-HFP (9.1 to 20 w %).

FIG. 8 is a graph depicting a Nyquist plot of the planar Zn metal symmetric cell with a voltage bias of 10 mV with a frequency range from 1 MHz to 10 Hz.

FIGS. 9A-9D are graphs depicting galvanostatic charge/discharge profiles of a Zn/AB/PVDF-HFP symmetric cell at currents of 1 (FIG. 9A), 2 (FIG. 9B), 4 (FIG. 9C), and mA/cm²_{geo}. (FIG. 9D). The stable charge/discharge plateaus during the cycling process indicate that the conductivity of the cell does not change much in the Zn plating/stripping process.

FIGS. 10A-10H depict the cycling performance and characterization of Zn/AB/PVDF-HFP electrode and Zn metal electrode. FIGS. 10A and 10E are graphs showing the cycling performance of Zn/AB/PVDF-HFP electrode (FIG. 10A) and Zn metal electrode (10E). The SEM images of the pristine (FIG. 10B) and cycled (FIGS. 10C-10D) Zn/AB/PVDF-HFP electrode. The SEM images of the pristine (FIG. 10F) and cycled (FIGS. 10G-10H) Zn metal electrode.

### DETAILED DESCRIPTION

A membrane for use to prepare an electrode for a rechargeable battery can include.

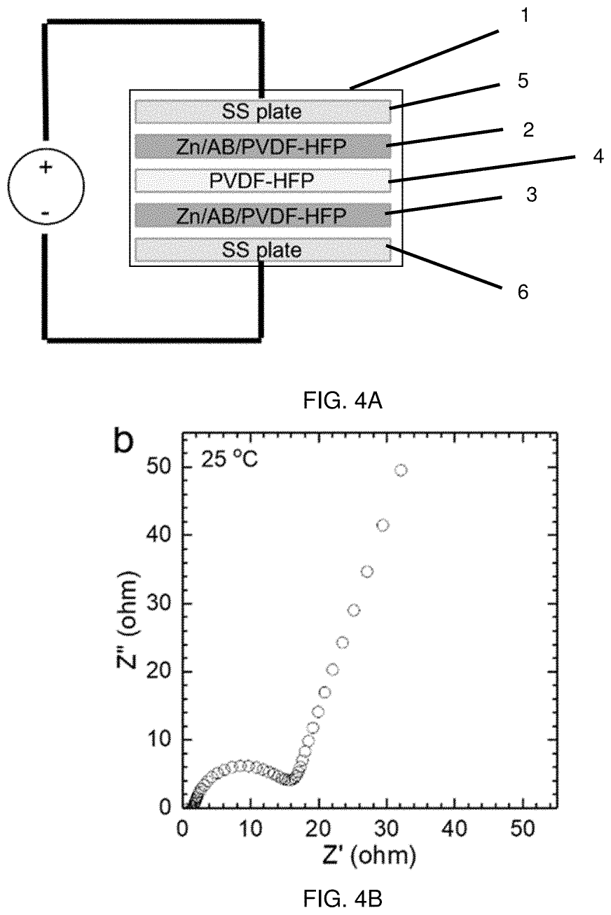

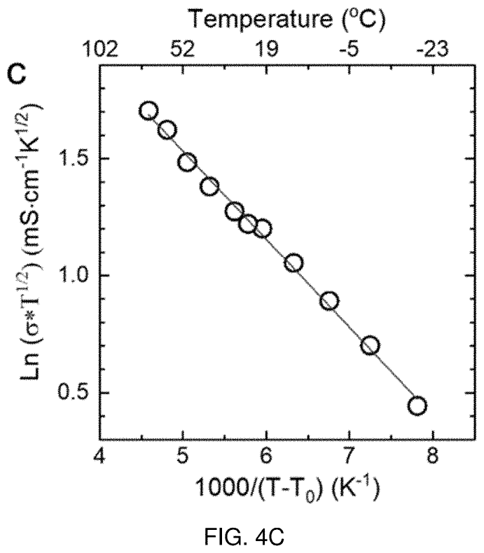

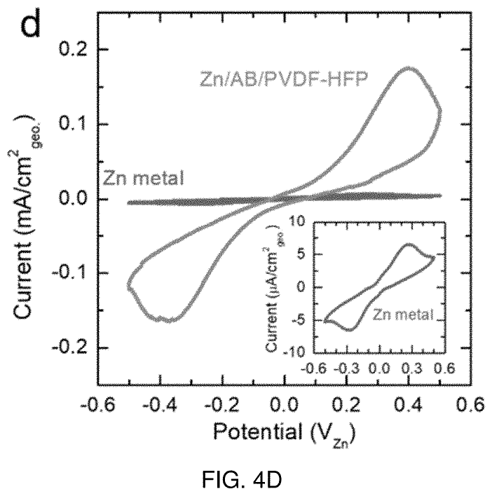

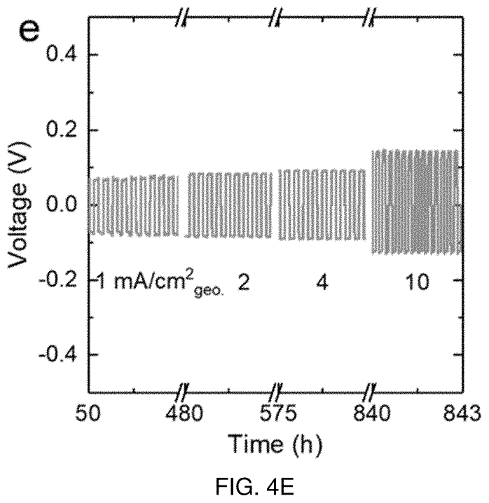

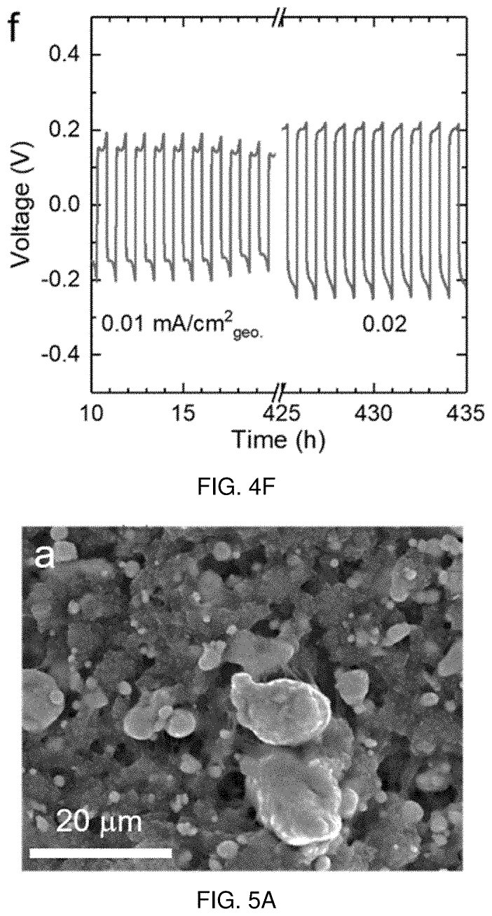

FIG. 4A schematically illustrates a rechargeable metal-air battery 1, which includes electrode 2, electrode 3, electrolyte 4, anode collector 5, and cathode collector 6. While FIG. 4A shows examples of materials for each of the elements identified, the structures can be generalized to the materials described herein. Each of anode collector 5 and cathode collector 6 can each be a metal surface, such as a stainless steel surface. Electrolyte 4 can include a separator material, such as the membrane described herein. Each of electrode 2 and cathode electrode 3 can be an electrode as described herein. In certain embodiments, one of the two electrodes can include a plurality of metal particles, such as zinc, for example, zinc powder. Battery 1 can be solvent free or can include an amount of an aprotic solvent such as an organic solvent, for example, propylene carbonate (PC), ethylene carbonate (EC), or porous inorganic particles, for example, silicon dioxide, or combinations thereof.

The membrane can include a gel polymer including a fluorinated polyolefin. The gel polymer can support an electrically conductive material to form a material useful to form an electrode. As an electrode, the gel polymer and electrically conductive material can form an ionic conductive binder. The ionic conductive binder has a porosity that can swell with exposure to an ionic liquid electrolyte to form an ionic liquid based gel polymer. The ionic conductive binder can form a network to support a plurality of metal particles, which can be an active material oxidized during battery cycling (for example, discharging and charging cycles). The electrolyte can include the metal in cationic form and an inert anion. When the metal is zinc, a flexible Zn film electrode can be formed. More specifically, the flexible Zn film electrode can be a flexible three-dimensional Zn film electrode.

The membrane can have a thickness of between 5 microns and 100 microns, between microns to 80 mircons, between 20 microns and 60 microns, and 25 microns to 40 microns. For example, the membrane can have a thickness of about 30 microns.

The membrane can be manufactured by creating a mixture including the gel polymer, and casting the mixture to form a wet film. The wet film is then dried to form the membrane. When the mixture includes the electrically conductive material, the dried film can be an electrode. Then the mixture further includes the plurality of metal particles, the dried film can be a battery electrode, which can be activated by exposure to electrolyte.

The fluorinated polyolefin can include a polyvinylidene fluoride, a polytetrafluoroethylene, a hexafluoropolypropylene, or a combination thereof. For example, the fluorinated polyolefin can include a copolymer of a polyvinylidene fluoride, a polytetrafluoroethylene, a hexafluoropolypropylene, or a combination thereof. In preferred embodiments, the fluorinated polyolefin can be poly(vinylidene fluoride)-co-hexafluoropropylene.

The electrically conductive material can be an electrically conductive network. For example, the electrically conductive material can include carbon black, carbon nanomaterials (such as carbon nanotubes or fullerenes), graphene, graphite, a conductive polymer, acetylene black, or inert metal particles. In preferred embodiments, the electrically conductive material can be acetylene black.

The ionic liquid electrolyte can include an imidazolium sulfonyl imide. The imidazolium sulfonyl imide can include 1-ethyl-3-methylimidazolium bis(trifluoromethylsulfonyl)imide.

The electrolyte can include a sulfonate salt, such as a trifluoromethanesulfonate salt. For example, the electrolyte can include zinc trifluoromethanesulfonate.

The plurality of metal particles can have average particle sizes of less than 30 microns, less than 20 microns, less than 10 microns, or less than 5 microns. For example, the particle size can be between 6 microns and 9 microns. In preferred embodiments, the plurality of metal particles can include zinc. The zinc can be a zinc powder. The zinc can be 99% pure or higher.

The electrolyte can include the metal in cationic form and an inert anion. For example, when the metal particles are zinc, the electrolyte can include a zinc salt. The inert anion of the electrolyte can be the same as the inert anion of the ionic liquid electrolyte. For example, the electrolyte can include a sulfonate salt, such as a trifluoromethanesulfonate salt, for example, zinc trifluoromethanesulfonate.

In certain circumstances, the metal battery can include an electrically conductive material, a plurality of metal particles, and an ionic liquid electrolyte. The ionic liquid based gel polymer can include a poly(vinylidene fluoride)-co-hexafluoropropylene. The electrically conductive material can include acetylene black. The plurality of metal particles can include zinc. The ionic liquid electrolyte can include a sulfonate salt.

It was found that an ionic liquid-based gel polymer (poly(vinylidene fluoride)-co-hexafluoropropylene, PVDF-HFP) and acetylene black (AB) can achieve a stable and flexible three-dimensional (3D) Zn/AB/PVDF-HFP film electrode with ionic and electronic conductive networks and high surface area, showing 26 times higher plating/stripping current than planar Zn plate. The electrode has low resistance, high rate capability and long cycle life (>800 h). A battery based on the electrode can be rechargeable and can be used in a high-cycle life thin-film RZMB.

A flexible Zn film electrode with ionic and electronic networks has been designed by utilizing ionic liquid based gel polymer as the binder, which can minimize the interface resistance between electrode and electrolytes. Ionic liquid electrolytes are good candidates for high surface area Zn anode due to their good electro(chemical) stability. (ref. 20) Ionic liquid based gel polymer electrolytes (GPEs) are good candidates to replace liquid electrolytes or separators in some special applications, like surface coating structure batteries.(ref. 25)

In one implementation, the ionic liquid (1-Ethyl-3-methylimidazolium bis(trifluoromethylsulfonyl)imide, EMIMTFSI)-based gel polymer (poly(vinylidene fluoride)-co-hexafluoropropylene, PVDF-HFP) electrolyte is employed as both Zn-ion transport membrane and binder in Zn film electrode, which provides a good interface between Zn film electrode and gel polymer electrolyte. Low-cost 1-Ethyl-3-methylimidazolium chloride (EMICl) should be another potential ionic liquid for the gel polymer electrolyte but the higher operation temperature (>100° C.) may limit its application in certain circumstances. In the flexible three-dimensional (3D) Zn film electrode (Zn/AB/PVDF-HFP), the acetylene black (AB) and the ionic liquid (EMIMTFSI)-based gel polymer (PVDF-HFP) are used as an electrically conductive network, and the ionic conductive binder, respectively. Due to the good stability of Zn particles in the ionic liquid (EMIMTFSI)-based gel polymer (PVDF-HFP) electrolyte (GPE), the Zn/AB/PVDF-HFP symmetric cell showed a long cycling lifetime (>800 h). The high specific surface area of effective Zn particles in the Zn/AB/PVDF-HFP electrode provides ˜26 times higher reactivity than the planar Zn metal electrode and high rate capability (up to 10 mA/cm²_{geo}). The excellent electrochemical performance of Zn/AB/PVDF-HFP symmetric cells provides a good opportunity to demonstrate a stable thin film RZMBs, which could be potentially placed on the surface of EVs as structure batteries.

### Examples

Materials

Poly(vinylidene fluoride-co-hexafluoropropylene) (PVDF-HFP, MW-455000, Sigma Aldrich) is used as the raw materials to prepare PVDF-HFP membranes. Acetone (99.9%, Sigma Aldrich) is used as the solvent to dissolve PVDF-HFP for membrane casting. Acetylene black (100% compressed, Strem Chemical Inc.) and zinc powder (6-9 μm, 97.5%, Alfa Aesar) are used to prepare Zn electrodes. Zinc(II) Bis(trifluoromethanesulfonyl)imide (ZnTFSI₂, ≥98%, TCI America) and 1-Ethyl-3-methylimidazolium bis(trifluoromethylsulfonyl)imide (EMIMTFSI, >99%, Sigma Aldrich) are used as ionic liquid electrolyte for PVDF-HFP swelling.

### Preparation of PVDF-HFP Membrane

0.5 g of PVDF-HFP pellets were stirred and dissolved in 4.5 ml acetone at 50° C. for 2 h. 2 ml of the above solution were transferred into a glass module (2.54×2.54 cm²). The PVDF-HFP membrane formed after 1 h at room temperature. Then the casted membrane was dried in a Büchi vacuum glass oven at 100° C. for 12 h. After drying, the membrane was transferred into the Ar-filled glove box for use. For the gelation, the dry PVDF-HFP membrane was immersed into 0.1 M Zn(TFSI)₂/EMIMTFSI electrolyte at 60° C. for 12 h. The PVDF-HFP gel membranes were wiped using Kimtech papers to remove the residual electrolyte from the surface for battery assembling.

### Preparation of Zn/AB/PVDF-HFP Electrode

0.2-0.5 g of PVDF-HFP pellets were stirred and dissolved in 4.5 g Acetone at 50° C. for 2 h. 0.2 g of Acetylene black (AB) and 1.8 g of Zn particles with specific surface area of 0.43 m²/g were grounded for 20 min. Then, the above grounded powder was transferred into the PVDF-HFP solution and stirred for overnight at 50° C. The uniform suspension was doctor bladed as the Zn/AB/PVDF-HFP film electrode with the gap of 100 um. Then, the electrode was dried in a Buchi vacuum glass oven at 100° C. for 12 h. After drying, the membrane was transferred into the Ar-filled glove box for use. For the gelation, the dry Zn/AB/PVDF-HFP film electrode was immersed into 0.1 M Zn(TFSI)₂/EMIMTFSI electrolyte at 60° C. for 12 h. The gelled Zn/AB/PVDF-HFP film electrode were wiped using Kimtech papers to remove the residual electrolyte from the surface for battery assembling.

### Zn Symmetric Battery Assembling and Testing

Two pieces of Zn/AB/PVDF-HFP film electrodes with a diameter of 1.27 cm were separated by a piece of PVDF-HFP gel membrane. The above sandwich symmetric components were put into a Tome-type cell with stainless steel plates as the current collectors. Electrochemical impedance spectroscopy (EIS) measurements were performed with a frequency range from 10 Hz to 1 MHz and voltage amplitude of 10 mV in an environment chamber at different temperatures (−20 to 70° C.). The galvanostatic charge/discharge measurements were conducted at room temperature at current densities from 1 to 2 mA/cm². The cyclic voltammetry measurements were performed at room temperature at the scanning rate of 10 mV/s in the potential range from −0.5 to 0.5 V. The control cells were assembled and tested with Zn plates as the active electrodes. All the above electrochemical measurements were conducted after 12 h of rest for cell stabilization.

### Characterizations of Materials

The PVDF-HFP membrane and Zn/AB/PVDF-HFP film electrode were characterized using x-ray diffraction (XRD, Bruker D2 Phaser), Raman spectroscopy (HORIBA Scientific LabRAM HR800), and scanning electron microscope (SEM, Zeiss Merlin). The cross-section film samples were broken after quenching in the liquid nitrogen. In XRD measurements, the applied voltage and current are 30 kV and 10 mA, respectively, using Cu-Kα radiation (λ=1.54178 Å). In the Raman spectra measurements, a red laser (λ=632.8 nm) was used with 50-fold magnification. An exposure time of 15 s with 600 grating was used, and each spectrum was accumulated 5 times. The cycled Zn/AB/PVDF-HFP and planar Zn electrodes were washed using anhydrous acetonitrile (ACN) for three times and then dried in a vacuum oven at room temperature.

### Results and Discussion

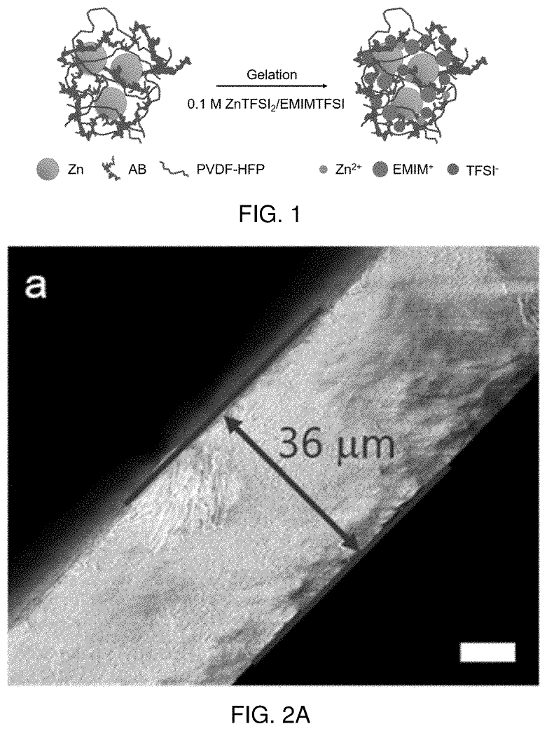

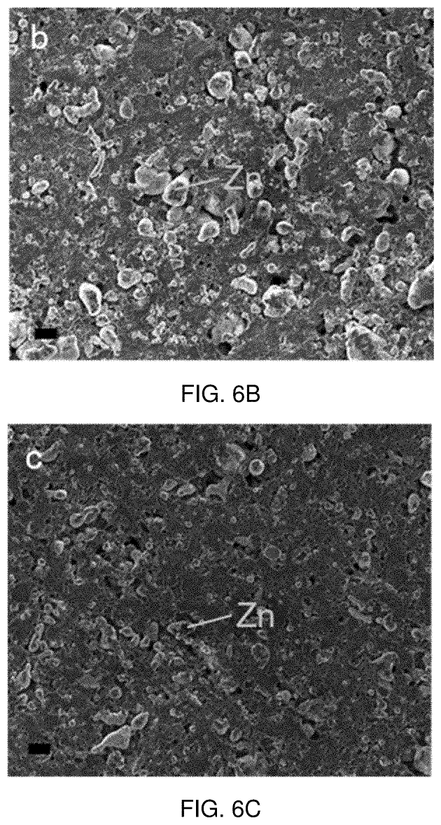

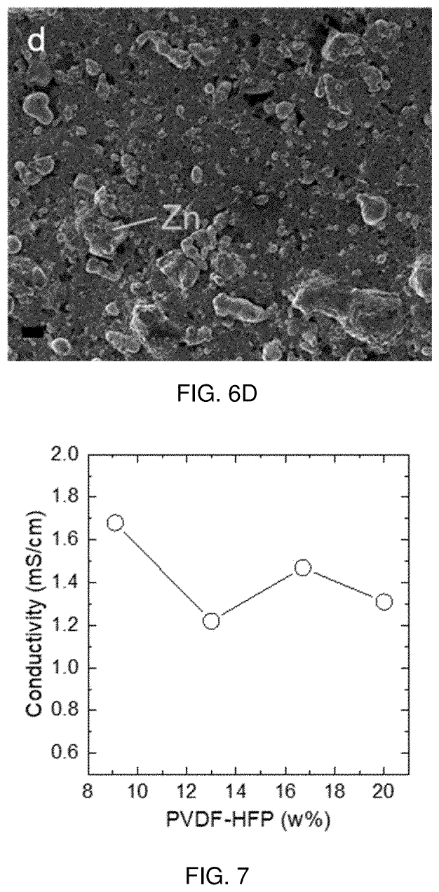

As shown in schematic structure of FIG. 1, PVDF-HFP polymer as the binder and acetylene black (AB) as the electronically conductive additive were used to make the well-connected network (FIGS. 6A-6D), which could provide good electronic conductivity (˜1 mS/cm, FIG. 7) to make a 3D Zn electrode. In the casted Zn/AB/PVDF-HFP film electrode, Zn particles were well dispersed in the AB/PVDF-HFP network (FIGS. 6A-6D). After gelation in 0.1 M ZnTFSI₂/EMIMTFSI ionic liquid electrolyte, the Zn²⁺, EMIM⁺, and TFSI-were absorbed in the PVDF-HFP 3D network, resulting in 3D ionic conductive channels in the Zn/AB/PVDF-HFP electrode. The PVDF-HFP network can also provide a compatible interface between the Zn/AB/PVDF-HFP electrode and PVDF-HFP membrane, resulting in a long cycling life (>800 h) with high geometric current densities (1-10 mA/cm²_{geo}.) without performance decay, which will be discussed in the following sections. To integrate the designed 3D Zn electrode and gel-polymer electrolyte, the ideal cathode should be a Zn-ion intercalation material, which could perform in a manner similar to rocking-chair battery like conventional Li-ion batteries. Except for the Zn-ion intercalation cathodes, the other options are these active materials with conversion reactions, like oxygen and sulfur electrode. (ref. 26, 27).

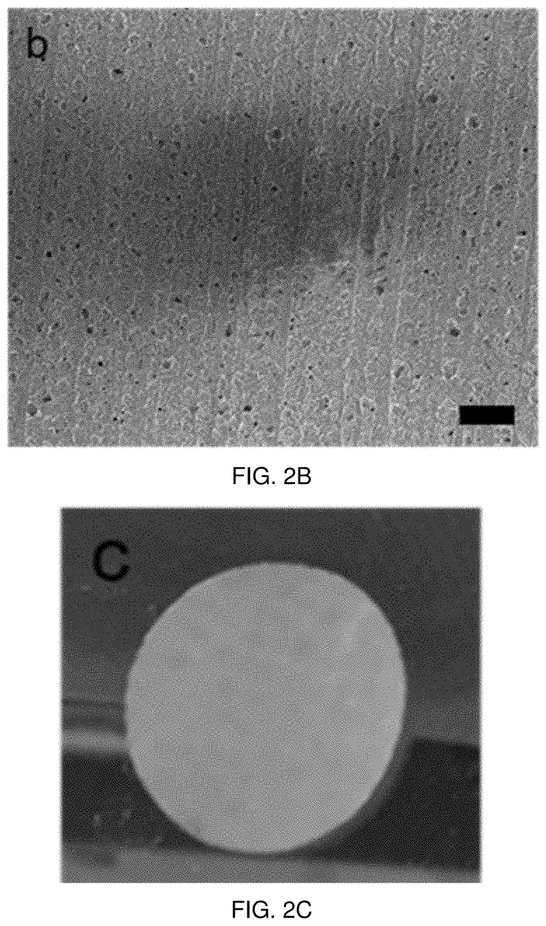

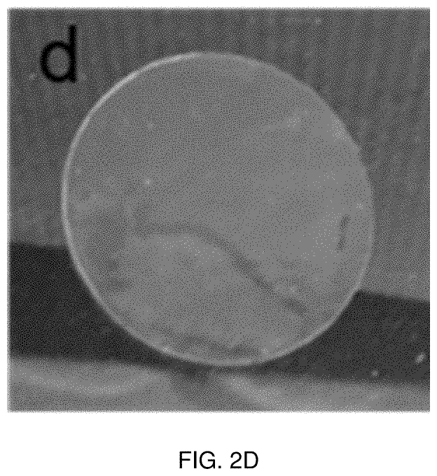

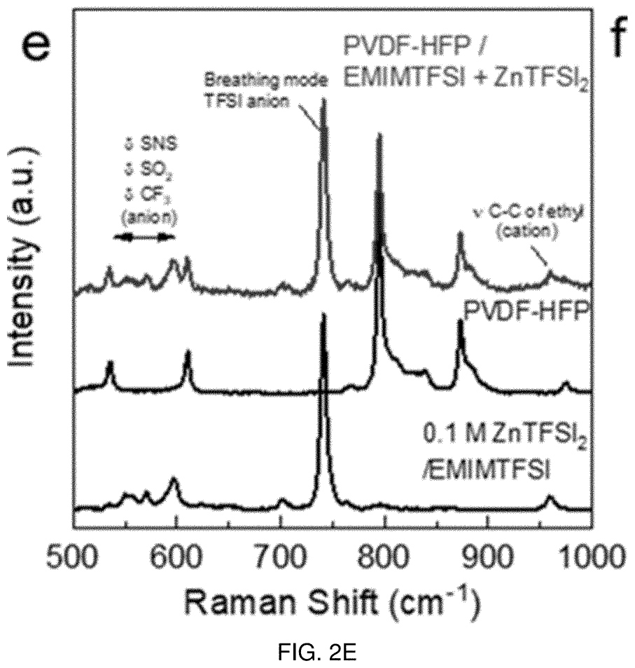

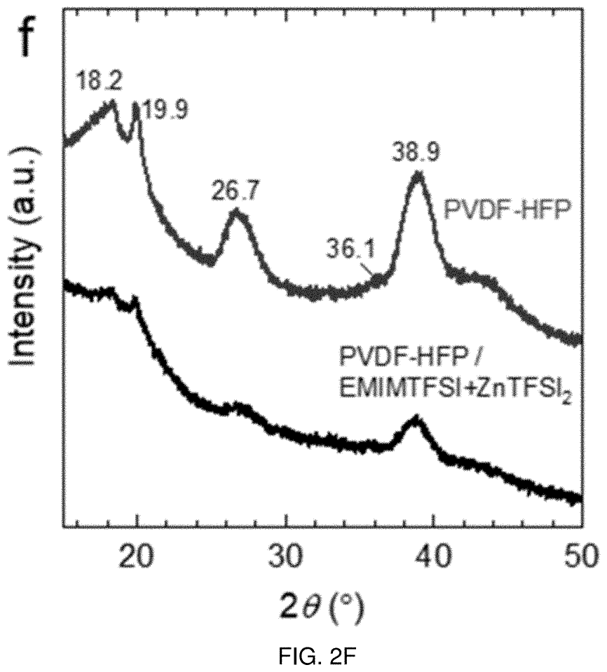

The PVDF-HFP membrane was cast on the glass module with a thickness of 30±10 μm, as shown in the cross-section SEM image (FIG. 2A). Although a few small pores (<100 nm) were found on the PVDF-HFP membrane in FIG. 2B, they are not through-holes as indicated in the cross-section image (FIG. 2A). Therefore, the dense membrane could absorb electrolytes to form a gel polymer network but not store electrolytes in pores. After gelation, the white dry PVDF-HFP membrane (FIG. 2C) becomes slightly transparent (FIG. 2D). Through Raman spectra shown in FIG. 2E, there are the peaks from both EMITFSI and Zn(TFSI)₂, indicating the absorption of electrolytes (0.1 M Zn(TFSI)₂ in EMITFSI) in the PVDF-HFP membrane after gelation. The swelling ratio (SR) of the GPE was obtained according to equation (1), which is 61±3%. Through XRD measurements in FIG. 2F, the main phase structure of casted PVDF-HFP film is α-phase due to the two clear peaks at 18.2° and 19.9°. (See, Ref. 28) After gelation in 0.1 M ZnTFSI/EMIMTFSI at 50° C. for 12 h, all these feature peaks are decreased, indicating the decrease of crystallinity.

SR=(m_{g}−m_{d})/m_{d} (1)

Where m_{g} and m_{d} are weights of the dry PVDF-HFP films and after swelling, respectively. The samples were immersed in 0.1 M ZnTFSI/EMIMTFSI ionic liquid at 50° C. for 12 h in the Ar-filled glove box.

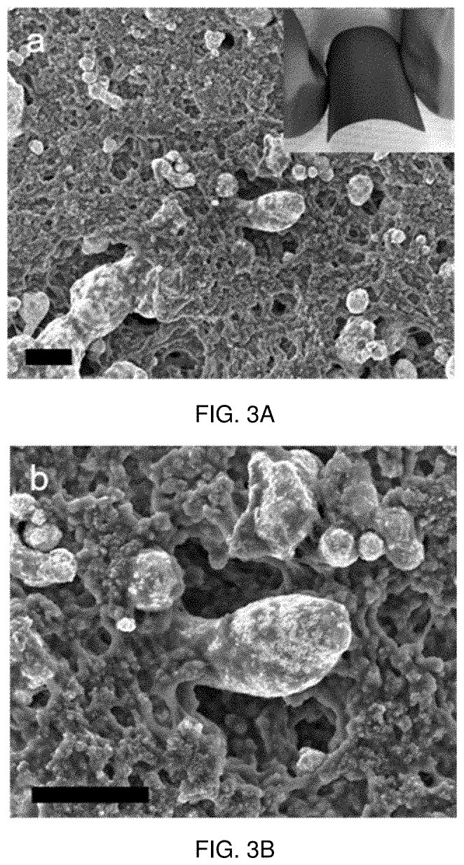

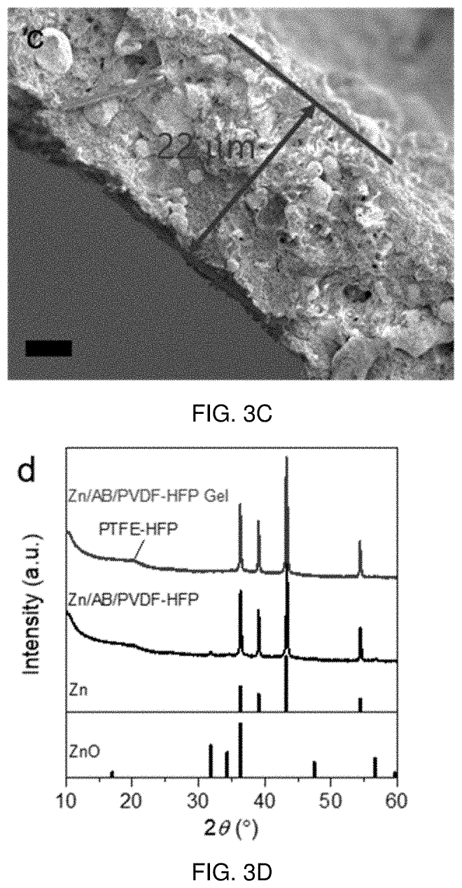

In order to increase the active surface area and the flexibility of a Zn electrode, we made a flexible 3D Zn electrode using AB as the electronic conductive network and PVDF-HFP as both the binder and ionic conductive network. As shown in FIGS. 3A-3B, Zn particles are uniformly anchored in the AB and PVDF-HFP (20 w %) networks. In addition, as the amount of PVDF-HFP was changed from 9.1 w % to 20 w %, the electronic conductivities of these electrodes (FIG. 7) do not change much. However, with increasing the PVDF-HFP, more Zn particles appear on the surface of the Zn/AB/PVDF-HFP electrode, as shown in FIGS. 6A-6D. To make sure that Zn particles are stably anchored in the PVDF-HFP network, we chose the electrode with 20 w % of PVDF-HFP for the electrochemical measurements (FIGS. 6A-6D). The thickness of the Zn/AB/PVDF-HFP electrode is 22 μm based on the SEM image of the cross-section (FIG. 3A-3C). The electrode also shows a homogeneous distribution of Zn particles vertically, indicating the Zn/AB/PVDF-HFP suspension's high mechanical stability (i.e. no disintegration or sedimentation due to gravity) during the casting process. There are several peaks from Zn and PVDF-HFP through XRD measurements in FIG. 3D. There is a small amount of ZnO in the Zn/AB/PVDF-HFP electrode but not in the pristine Zn powder, which may be from the corrosion of the Zn particles during the suspension preparation.

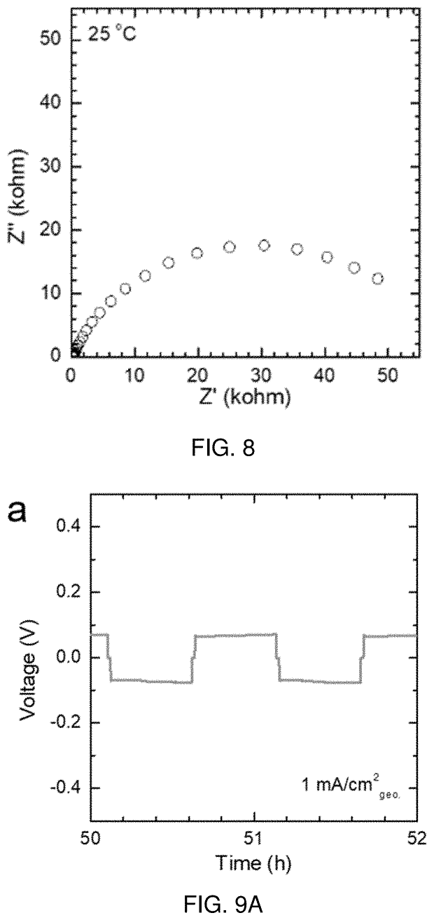

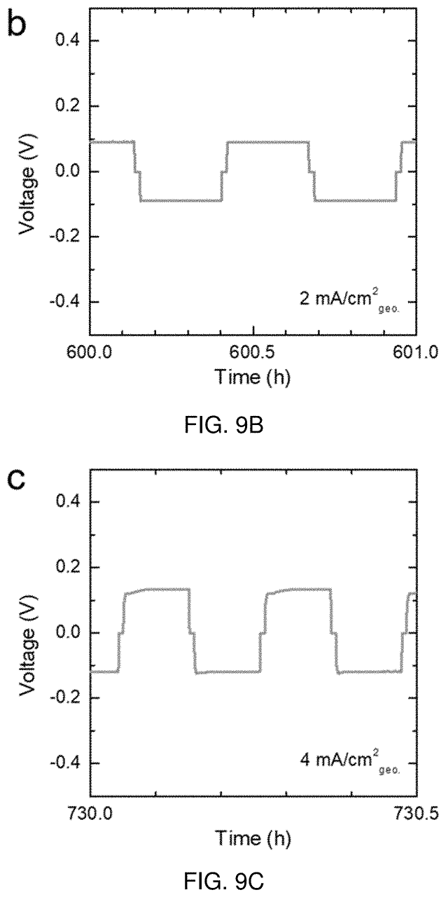

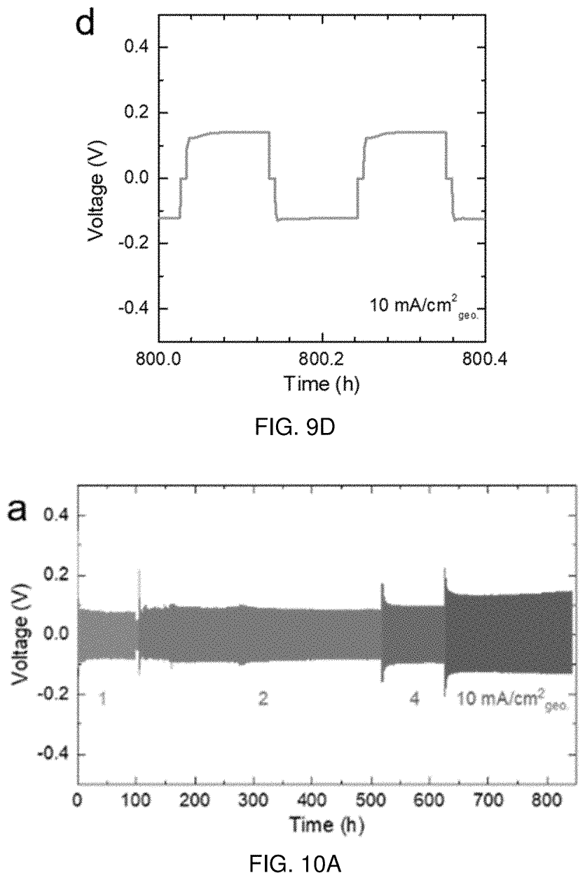

The symmetric Zn/AB/PVDF-HFP cell was assembled which schematic structure is shown in FIG. 4A. From the Nyquist plot at 25° C. in FIG. 4B, the clear semi-circle (˜13.4 ohm) is assigned to the impedance from PVDF-HFP gel polymer electrolyte, showing the ionic conductivity is 1.1×10⁻⁴ S/cm. Liu et al. demonstrated Zinc trifluoromethanesulfonate (Zn(Tf)₂)/PVDF-HFP polymer electrolyte without ionic liquid, showing around a lower ionic conductivity (˜2.4×10⁻⁵ S/cm). (ref. 29) Adding EMITf can enhance the conductivity of the Zn(Tf)₂/PVDF-HFP polymer electrolyte up to 1.4×10⁻⁴ S/cm. (ref. 30). Adding organic solvents (e.g., propylene.te (PC), ethylene carbonate (EC)) (ref. 31) or porous inorganic particles (e.g. SiO₂) (ref. 32) can realize the conductivity of the order of 10⁻³ S/cm. The first intersection point shows the low contact resistance (˜1.7 ohm), indicating the good electronic conductivity (8.5×10⁻⁴ S/cm) of the Zn/AB/PVDF-HFP electrode. However, the Zn plate symmetric cell with the PVDF-HFP gel polymer shows a much higher interface resistance (>5×10⁴ ohm, FIG. 8), which resulted in the poor electrochemical performance as shown in the later section. As shown in FIG. 4C, the ionic conductivity of the PVDF-HFP gel polymer electrolyte with the temperature obeys the Vogel-Tammen-Fulcher (VTF) behavior throughout the temperature range from −20 to 70° C., and they are fitted to the equation:

$$σ = A {T}^{- 1 / 2} exp ( - \frac{{E}_{a}}{{K}_{B} ( T - {T}_{0} )} ) \qquad ( 2 )$$

where A is the pre-exponential factor, Eₐ is the activation energy, K_{B} is the Boltzmann constant, T is the testing temperature, and T₀ is the equilibrium glass transition temperature, which is deduced from the equation (3). (ref. 33)

T₀=T_{g}−50 K (3)

where the glass transition point T_{g} of EMIMTFSI is 175 K. (ref. 34)

The VFT behavior has been largely reported for ionic liquid electrolytes. (refs. 35-37) The activation energy (Eₐ) is 0.03 eV from the fitting results, which is comparable to the previously reported value (0.03 eV) for PVDF-HFP+EMIMTFSI gel electrolyte. (ref. 38) The cyclic voltammetry (CV) curves in FIG. 4G shows the good reversibility of Zn plating/stripping in ionic liquid (0.1 M ZnTFSI₂/EMIMTFSI) based GPE for both the Zn/AB/PVDF-HFP electrode and the planar Zn metal electrode, indicating that the high stability of Zn against the GPE. The oxidation/reduction current density of the Zn/AB/PVDF-HFP electrode is ˜0.17 mA/cm²_{geo}, which is ˜26 times higher than that of a planar Zn metal electrode. The high kinetics of the Zn/AB/PVDF-HFP electrode is attributed to the high surface area of Zn particles. The reversibility and stability of the Zn/AB/PVDF-HFP electrode were investigated using symmetric cell at constant currents, as shown in FIG. 4E. After cycling over 840 h (100 cycles at 1 mA/cm²_{geo}, 400 cycles at 2 mA/cm²_{geo}, 200 cycles at 4 mA/cm²_{geo}, and 1000 cycles at 10 mA/cm²_{geo}), the Zn/AB/PVDF-HFP symmetric cell still showed stable charge-discharge profiles. No obvious voltage plateau change in Zn stripping and plating process (Figure S4), indicating that the conductivity of the cell doesn't change much in the Zn plating/stripping process. As a comparison, the Zn plate symmetric cell cannot be cycled at high currents (e.g., 1 mA/cm²_{geo}.) due to its low surface area and poor interface contact with GPE (FIG. 4F). At low currents of 0.01 and 0.02 mA/cm²_{geo}, the Zn plate symmetric cell still showed high overpotentials. The utilization of Zn in the Zn/AB/PVDF-HFP (FIG. 4E) and Zn planar electrodes (FIG. 4F) in the charge/discharge process are ˜51% and 3×10⁻³⁰, respectively. In the recent studies, the Zn foil electrodes in aqueous (e.g. 1 M Zn(CF₃SO₃)₂+25 mM Zn(H₂PO₄)₂, ZnCl₂-2.33H₂O (refs. 38, 39, 40)), non-aqueous (1.0 M Zn(TFSI)₂ in AN) (ref. 41), and polymer-based electrolytes (Zincic perfluorinated sulfonic acid membrane, Zn(ClO₄)₂/polyacrylamide) (refs. 42, 43) can achieved long cycling life (>1000 h) at current density ranging from 0.1 to 5 mA/cm²_{geo}. Compared with the reported work, the Zn/AB/PVDF-HFP electrode designed here can achieve the highest current density (10 mA/cm²_{geo}.), which could attribute to its higher effective surface area than planar Zn foil, as summarized in Table 1. In short, the Zn/AB/PVDF-HFP symmetric cells, with high surface area, good contact with GPE, and good stability with ionic liquids, showed high reactivity, high-rate capability, and good cycling stability.

TABLE 1
The comparison of previously reported cycling performance of Zn symmetric
cells in aqueous, non-aqueous, and polymer-based electrolytes.

| | | | Applied | | |
|---|---|---|---|---|---|
| | | | current | Cycling | |
| Systems | Electrolytes | Electrode | (mA/cm^{²} ^{geo.}) | time (h) | references |
| Aqueous | 1 m Zn(TFSI)₂ + | Zn/carbon/PVDF | 0.2 | 170 | 1 |
| | 20 m LiTFSI | | | | |
| | 3M Zn(CF₃SO₃)₂ | Zn foil | 0.1-1.0 | 800 | 2 |
| | 1M Zn(CF₃SO₃)₂ | Zn foil | 0.2 | 1580 | 3 |
| | 1M Zn(Oac)₂/([Ch]Oac + | Zn sheet | 0.2 | 200 | 4 |
| | 30 w % water mixtures) | | | | |
| | 1M Zn(CF₃SO₃)₂ + 25 mM | Zn foil | 1.0 | 1200 | 5 |
| | Zn(H₂PO₄)₂ | | | | |
| | 2M ZnSO₄ + 0.1M MnSO₄ | Zn plated on Cu | 2.0 | 150 | 6 |
| | | foam | | | |
| | ZnCl₂-2.33H₂O | Zn foil | 5.0 | 1000 | 7 |
| | 0.5 m Zn(CF₃SO₃)₂ + | Zn/carbon/PVDF | 1.0 | 80 | 1 |
| | 18 m NaClO₄ | | | | |
| non- | 0.5M Zn(CF₃SO₃)₂ in AN | Zn foil | 1.25 | 320 | 8 |
| aqueous | 0.5M Zn(TFSI)₂ in AN | Zn foil | 1.25 | 320 | 8 |
| | 1.0M Zn(TFSI)₂ in AN | Zn foil | 0.5 | 1000 | 9 |
| | Zn(CF₃SO₃)₂/PVDF-HFP | Zn foil | 0.05 | 100 | 10 |
| Polymer- | Zincic perfluorinated sulfonic | Zn plate | 2.0 | 1000 | 11 |
| based | acid membrane | | | | |
| electrolyte | porous PVA-5 w % SiO₂ | Zn foil | 3.0 | 48 | 12 |
| | ZnSO₄/Li₂SO₄/polyacrylamide | Zn foil | 3.0 | 150 | 13 |
| | Zn(ClO₄)₂/polyacrylamide | Zn foil | 3.0 | 2500 | 13 |
| | Zn(TFSI)₂/EMITFSI/PVDF- | Zn/AB/PVDF- | 1.0-10.0 | 840 | Described |
| | HFP | HFP | | | herein |

Note:
Zn(TFSI)₂: Zinc bis(trifluoromethylsulfonyl)imide; Zn(CF₃SO₃)₂: Zinc trifluoromethanesulfonate; Zn(Oac)₂: Zinc acetate; [Ch]Oac: choline acetate; AN: Acentonitrile; PVA: Poly(vinyl alcohol).

References for Table 1 follow below, each of which is incorporated by reference in its entirety.
1 F. Wang, O. Borodin, T. Gao, X. Fan, W. Sun, F. Han, A. Faraone, J. A. Dura, K. Xu, and C. Wang, Nat. Mater. 17, 543 (2018).
2 N. Zhang, F. Cheng, Y. Liu, Q. Zhao, K. Lei, C. Chen, X. Liu, and J. Chen, J. Am. Chem. Soc. 138 (39), 12894 (2016).
3 J. Liu, Z. Khanam, S. Ahmed, T. Wang, H. Wang, and S. Song, ACSAppl. Mater. Interfaces 13 (14), 16454 (2021).
4 Z. Liu, G. Pulletikurthi, and F. Endres, ACSAppl. Mater. Interfaces 8 (19), 12158 (2016).
5 X. Zeng, J. Mao, J. Hao, J. Liu, S. Liu, Z. Wang, Y. Wang, S. Zhang, T. Zheng, J. Liu, P. Rao, and Z. Guo, Adv. Mater. 33 (11), 2007416 (2021).
6 C. Li, X. Shi, S. Liang, X. Ma, M. Han, X. Wu, and J. Zhou, Chem. Eng. J. 379, 122248 (2020).
7 C.-Y. Chen, K. Matsumoto, K. Kubota, R. Hagiwara, and Q. Xu, Adv. Energy Mater. 9 (22), 1900196 (2019).
8 A. S. Etman, M. Carboni, J. Sun, and R. Younesi, Energy Technology 8 (9), 2000358 (2020).
9 N. Zhang, Y. Dong, Y. Wang, Y. Wang, J. Li, J. Xu, Y. Liu, L. Jiao, and F. Cheng, ACSAppl. Mater. Interfaces 11 (36), 32978 (2019).
10 J. Liu, Z. Khanam, R. Muchakayala, and S. Song, J Mater. Sci. Mater. Electron. 31 (8), 6160 (2020).
11 Y. Cui, Q. Zhao, X. Wu, Z. Wang, R. Qin, Y. Wang, M. Liu, Y. Song, G. Qian, Z. Song, L. Yang, and F. Pan, Energy Storage Mater. 27, 1 (2020).
12 X. Fan, J. Liu, Z. Song, X. Han, Y. Deng, C. Zhong, and W. Hu, Nano Energy 56, 454 (2019).
13 J. Huang, X. Chi, Y. Du, Q. Qiu, and Y. Liu, ACS Appl. Mater. Interfaces 13 (3), 4008 (2021).

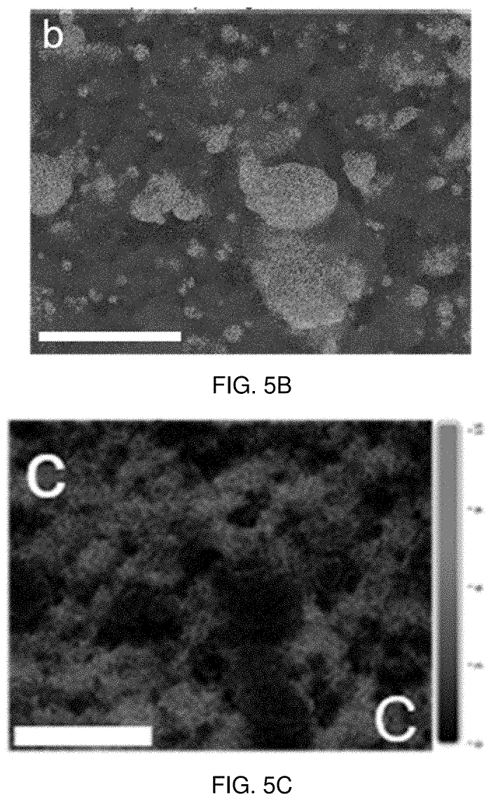

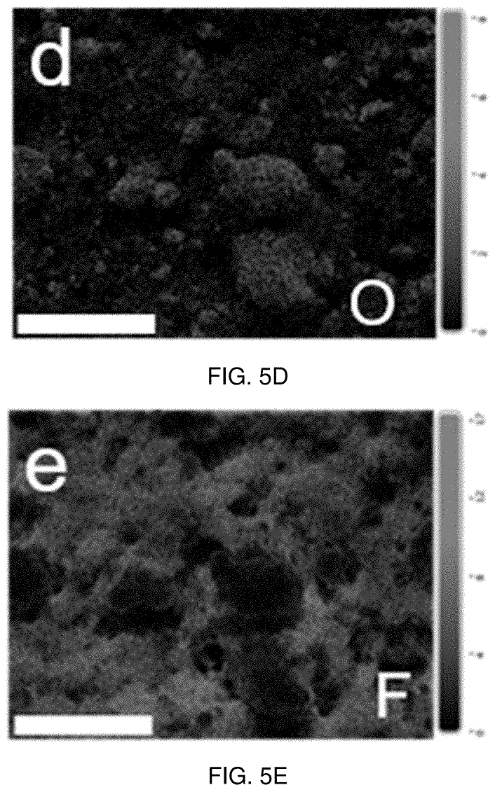

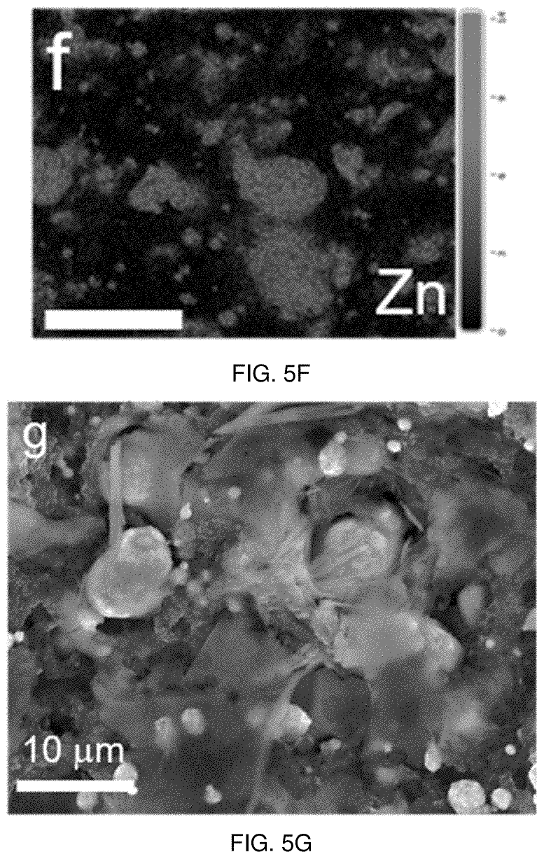

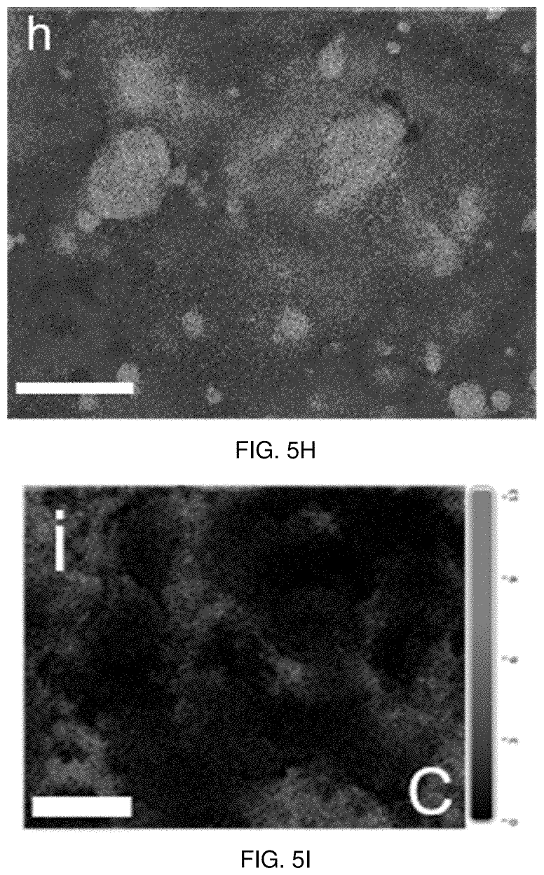

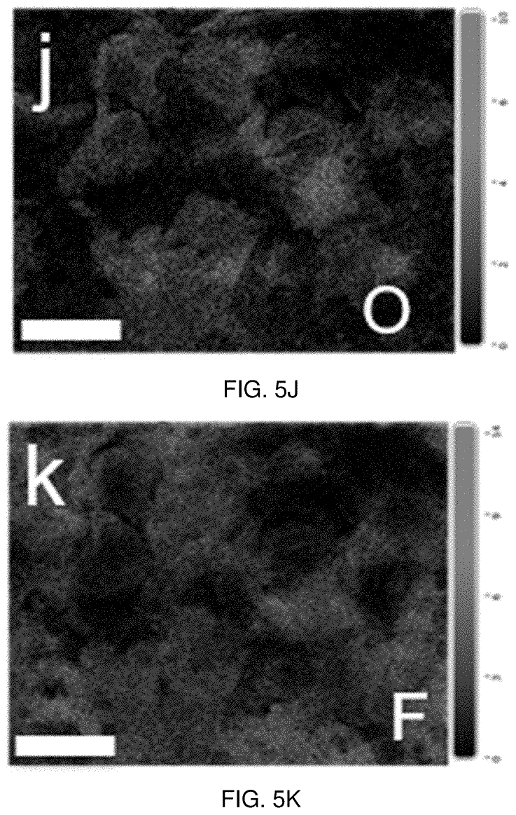

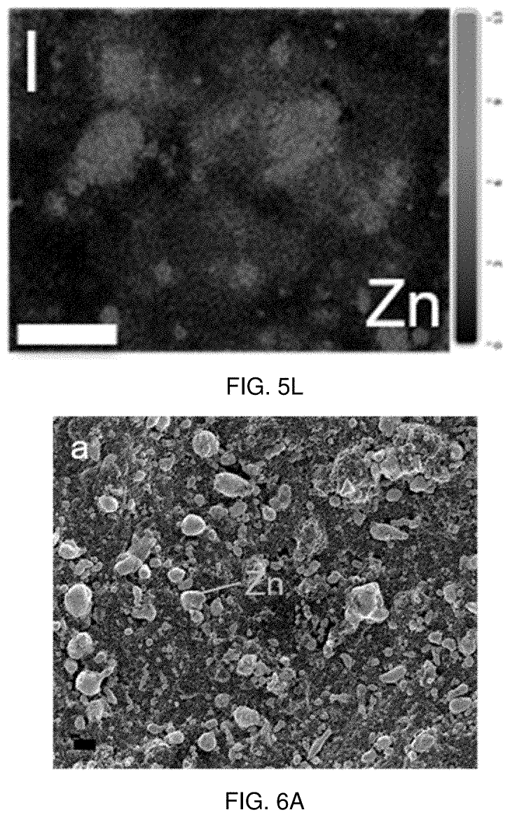

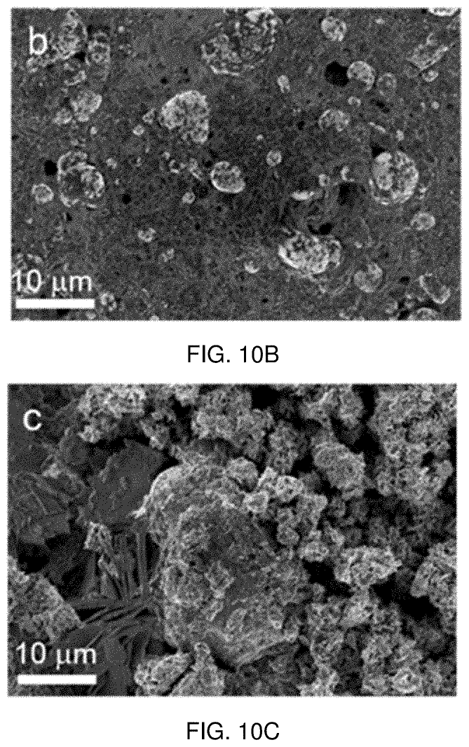

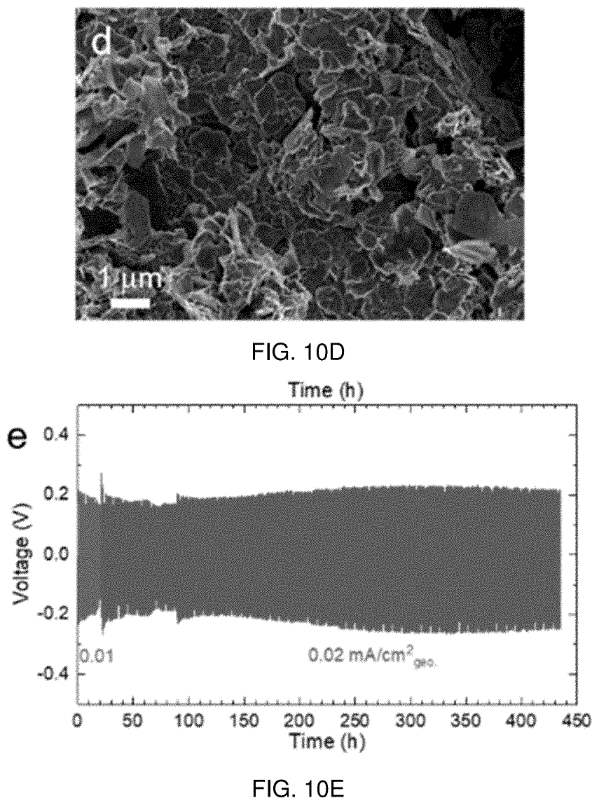

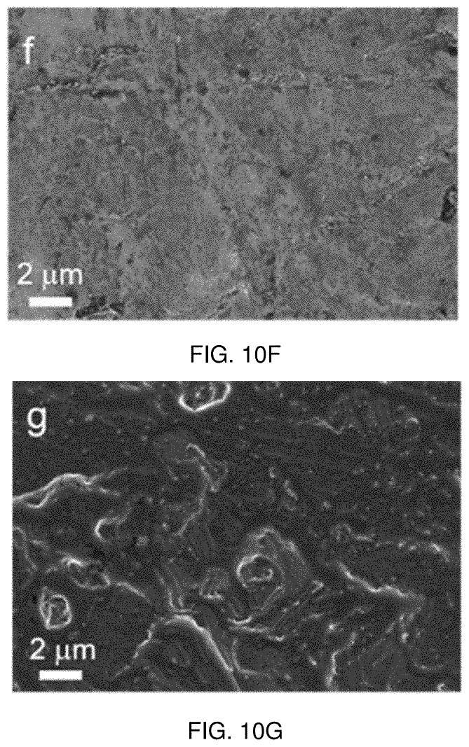

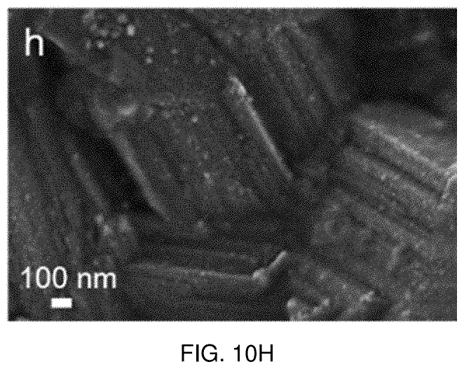

To further analyze Zn stripping and plating, we characterized the Zn/AB/PVDF-HFP electrode before and after cycling using SEM and EDS mapping. From the SEM images (FIGS. 10B-10D) of the pristine and cycled Zn/AB/PVDF-HFP electrode at current densities from 1-10 mA/cm²_{geo}. (FIG. 10A), small Zn particles were plated on the electrode surface without Zn dendrites formation after cycling. The Zn/AB/PVDF-HFP electrode (24 μm, 4.28 mg) has an active surface area of 13 cm², which is ˜ 10 times higher than the geometric surface area of the planar Zn plate (1.27 cm², 181 mg). The current density required for Zn dendrite formation within a given time can be estimated from Sand's relationship. (ref. 44) Hence, if dendrite forms at 0.5 mA/cm²_{geo}. within 1 hour for a planar electrode, it takes 5 mA/cm²_{geo} for dendrites to develop on Zn/AB/PVDF-HFP electrode surface within the same time. The required current density can be increased by increasing the volume fraction of Zn or by increasing the thickness of Zn/AB/PVDF-HFP electrode. Therefore, zinc dendrite formation can be reduced or possibly prevented in the Zn/AB/PVDF-HFP electrode. The SEM images (FIGS. 10F-10H) of the pristine and cycled Zn metal electrode (FIG. 10E) suggest that Zn stripping/plating happened along the Zn metal grain boundaries. Due to the low current densities (0.01 and 0.02 mA/cm²_{geo}.) and shallow cycling capacity (up to 0.01 mAh/cm²_{geo}.) in FIG. 4F, there was no Zn dendrite formation on the Zn metal electrode after cycling. In FIGS. 5A-5F, clear boundaries can be seen between Zn particles and AB or PVDF-HFP networks in the pristine electrode. With a homogeneous distribution of Zn particles in AB and PVDF-HFP networks, the Zn/AB/PVDF-HFP electrode showed high electronic (˜1 mS/cm) and ionic conductivities (˜0.1 mS/cm) at room temperature. After cycling in FIGS. 5G-5L, the boundary of Zn particles in the electrode become blur and lots of small Zn particles appear on the electrode surface. The above results could support that the Zn plating not only happens on the Zn particles but also on the carbon particles. Therefore, the Zn/AB/PVDF-HFP electrode has an even more electrochemically active surface area with increasing cycling number because more and more AB surfaces will be utilized as the active sites for Zn plating and stripping. Although degradation of the 3D Zn electrode was not observed, it is worth discussing the potential degradation. First, the potential degradation may be from the Zn corrosion if the battery is contaminated by water. Second, the degradation of mechanical properties may be observed after a long cycling process because of potential uneven Zn stripping/plating in the 3D network, which should be investigated in the future.

An ionic-liquid (EMIMTFSI) based gel polymer (PVDF-HFP) was employed as the ionic conductive binder to make the flexible 3D Zn/AB/PVDF-HFP electrode which has good contact with the gel polymer electrolyte. The high effective surface area of the 3D Zn/AB/PVDF-HFP electrode can not only provide high electrochemical active surface area (˜26 times higher than Zn metal plate) but also guarantee dendrite-free Zn plating at high geometric currents (up to 10 mA/cm²_{geo}.). With inert ionic liquid-based gel polymer electrolyte, the Zn/AB/PVDF-HFP electrode exhibited excellent stability (>800 h cycling time) at high current (1, 2, 4, and 10 mA/cm²_{geo}.). This Zn anode design provides a new way to overcome the poor interface with the gel polymer electrolytes for use in a stable rechargeable Zn metal batteries.

The following references are incorporated by reference in their entirety.
1. J. Liu et al., Pathways for practical high-energy long-cycling lithium metal batteries. Nature Energy 4, 180 (2019/03/01, 2019).
2. W. Xu, Y. Wang, Recent Progress on Zinc-Ion Rechargeable Batteries. Nano-Micro Letters 11, 90 (2019/10/17, 2019).
3. S. J. Banik, R. Akolkar, Suppressing Dendrite Growth during Zinc Electrodeposition by PEG-200 Additive. Journal of The Electrochemical Society 160, D519 (2013).
4. Z. Liu et al., Dendrite-Free Nanocrystalline Zinc Electrodeposition from an Ionic Liquid Containing Nickel Triflate for Rechargeable Zn-Based Batteries. Angewandte Chemie International Edition 55, 2889 (2016).
5. F. Wang et al., Highly reversible zinc metal anode for aqueous batteries. Nature Materials, (2018/04/16, 2018).
6. J. F. Parker, I. R. Pala, C. N. Chervin, J. W. Long, D. R. Rolison, Minimizing Shape Change at Zn Sponge Anodes in Rechargeable Ni—Zn Cells: Impact of Electrolyte Formulation. Journal of The Electrochemical Society 163, A351 (Jan. 1, 2016, 2016).
7. J. F. Parker et al., Rechargeable nickel-3D zinc batteries: An energy-dense, safer alternative to lithium-ion. Science 356, 415 (2017).
8. J. Zheng et al., Reversible epitaxial electrodeposition of metals in battery anodes. Science 366, 645 (2019).
9. Y. G. Zhu et al., High-energy and high-power Zn-Ni flow batteries with semi-solid electrodes. Sustainable Energy & Fuels, (2020).
10. G. Garcia, E. Ventosa, W. Schuhmann, Complete Prevention of Dendrite Formation in Zn Metal Anodes by Means of Pulsed Charging Protocols. ACS Applied Materials & Interfaces 9, 18691 (2017/06/07, 2017).
11. X. Ren et al., Localized high-concentration sulfone electrolytes for high-efficiency lithium-metal batteries. Chem 4, 1877 (2018).
12. H. Jia et al., High-Performance Silicon Anodes Enabled By Nonflammable Localized High-Concentration Electrolytes. Advanced Energy Materials 9, 1900784 (2019).
13. Z. Du et al., A mechanically robust, biodegradable and high performance cellulose gel membrane as gel polymer electrolyte of lithium-ion battery. Electrochimica Acta 299, 19 (2019).
14. F. Baskoro, H. Q. Wong, H.-J. Yen, Strategic structural design of a gel polymer electrolyte toward a high efficiency lithium-ion battery. ACS Applied Energy Materials 2, 3937 (2019).
15. D. Lei et al., Cross-linked beta alumina nanowires with compact gel polymer electrolyte coating for ultra-stable sodium metal battery. Nature communications 10, 1 (2019).
16. C. Luo et al., Mechanically Robust Gel Polymer Electrolyte for an Ultrastable Sodium Metal Battery. Small 16, 1906208 (2020).
17. S. Ghorai et al., Enhanced Removal of Methylene Blue and Methyl Violet Dyes from Aqueous Solution Using a Nanocomposite of Hydrolyzed Polyacrylamide Grafted Xanthan Gum and Incorporated Nanosilica. ACS Applied Materials & Interfaces 6, 4766 (2014/04/09, 2014).
18. H. Li et al., Waterproof and Tailorable Elastic Rechargeable Yarn Zinc Ion Batteries by a Cross-Linked Polyacrylamide Electrolyte. ACS Nano 12, 3140 (2018/04/24, 2018).
19. J. P. Tafur, J. Abad, E. Román, A. J. Fernindez Romero, Charge storage mechanism of MnO2 cathodes in Zn/MnO2 batteries using ionic liquid-based gel polymer electrolytes. Electrochemistry Communications 60, 190 (2015/11/01/, 2015).
20. H. Ohno, Electrochemical aspects of ionic liquids. (John Wiley & Sons, 2005).
21. P. Yu et al., Flexible Zn-Ion Batteries: Recent Progresses and Challenges. Small 15, 1804760 (2019).
22. J. Fu et al., Flexible High-Energy Polymer-Electrolyte-Based Rechargeable Zinc-Air Batteries. Advanced Materials 27, 5617 (2015).
23. Z. Wang, X. Meng, Z. Wu, S. Mitra, Development of flexible zinc-air battery with nanocomposite electrodes and a novel separator. Journal of Energy Chemistry 26, 129 (2017/01/01/, 2017).
24. K. Wongrujipairoj, L. Poolnapol, A. Arpornwichanop, S. Suren, S. Kheawhom, Suppression of zinc anode corrosion for printed flexible zinc-air battery. physica status solidi (b) 254, 1600442 (2017).
25. J. P. Tafur, A. J. Fernández Romero, Electrical and spectroscopic characterization of PVdF-HFP and TFSI-ionic liquids—based gel polymer electrolyte membranes. Influence of ZnTf2 salt. Journal of Membrane Science 469, 499 (2014/11/01/, 2014).
26. W. Sun, F. Wang, B. Zhang, M. Zhang, V. Kipers, X. Ji, C. Theile, P. Bieker, K. Xu, C. Wang, and M. Winter, Science 371 (6524), 46 (2021).
27. M. Cui, J. Fei, F. Mo, H. Lei, and Y. Huang, ACS Appl. Mater. Interfaces 13 (46), 54981 (2021).
28. C.-H. Du, B.-K. Zhu, and Y.-Y. Xu, J Mater. Sci. 41 (2), 417 (2006).
29. J. Liu, Z. Khanam, R. Muchakayala, and S. Song, J. Mater. Sci. Mater. Electron. 31 (8), 6160 (2020).
30. J. Liu, S. Ahmed, Z. Khanam, T. Wang, and S. Song, Polymers 12 (8), 1755 (2020).
31. G. G. Kumar and S. Sampath, Solid State Ionics 160 (3), 289 (2003).
32. X. Fan, J. Liu, Z. Song, X. Han, Y. Deng, C. Zhong, and W. Hu, Nano Energy 56, 454 (2019).
33. B. Qiao, S. Mohapatra, J. Lopez, G. M. Leverick, R. Tatara, Y. Shibuya, Y. Jiang, A. France-Lanord, J. C. Grossman, R. Gómez-Bombarelli, J. A. Johnson, and Y. Shao-Horn, ACS Cent. Sci. 6 (7), 1115 (2020).
34. H. Gupta and R. K. Singh, “Ionic Liquid-Based Gel Polymer Electrolytes for Application in Rechargeable Lithium Batteries”, in Energy Storage Battery Systems—Fundamentals and Applications (IntechOpen, 2020).
35. A. Noda, K. Hayamizu, and M. Watanabe, J Phys. Chem. B 105 (20), 4603 (2001).
36. T.-Y. Wu, L. Hao, P.-R. Chen, and J.-W. Liao, Int. J. Electrochem. Sci 8, 2606 (2013).
37. C. Ferrara, V. Dall'Asta, V. Berbenni, E. Quartarone, and P. Mustarelli, J Phys. Chem. C 121 (48), 26607 (2017).
38. J. P. Tafur and A. J. Femindez Romero, J. Membr. Sci. 469, 499 (2014).
39. X. Zeng, J. Mao, J. Hao, J. Liu, S. Liu, Z. Wang, Y. Wang, S. Zhang, T. Zheng, J. Liu, P. Rao, and Z. Guo, Adv. Mater. 33 (11), 2007416 (2021).
40. C.-Y. Chen, K. Matsumoto, K. Kubota, R. Hagiwara, and Q. Xu, Adv. Energy Mater. 9 (22), 1900196 (2019).
41. N. Zhang, Y. Dong, Y. Wang, Y. Wang, J. Li, J. Xu, Y. Liu, L. Jiao, and F. Cheng, ACS Appl. Mater. Interfaces 11 (36), 32978 (2019).
42. Y. Cui, Q. Zhao, X. Wu, Z. Wang, R. Qin, Y. Wang, M. Liu, Y. Song, G. Qian, Z. Song, L. Yang, and F. Pan, Energy Storage Mater. 27, 1 (2020).
43. J. Huang, X. Chi, Y. Du, Q. Qiu, and Y. Liu, ACS Appl. Mater. Interfaces 13 (3), 4008 (2021).
44. V. Yufit, F. Tariq, D. S. Eastwood, M. Biton, B. Wu, P. D. Lee, and N. P. Brandon, Joule 3 (2), 485 (2019).

The foregoing is merely an illustrative example. Other implementations may be made without departing from the scope of the disclosure. Reference numbers in parentheses “( )” herein refer to the corresponding references listed in the attached Bibliography, which forms a part of this Specification, and each of the references listed in the Bibliography is incorporated by reference herein. It should be understood that the subject matter defined in the appended claims is not necessarily limited to the specific implementations described above. The specific implementations described above are disclosed as examples only.

What is claimed is:

1. A zinc film electrode for a battery comprising an ionic liquid based gel polymer as a binder.

2. The zinc film electrode of claim 1, further comprising an electrically conductive network.

3. A rechargeable zinc metal battery comprising:
a Zn film electrode comprising an ionic liquid based gel polymer as a binder; and
an electrolyte.

4. The rechargeable zinc metal battery of claim 3, wherein the Zn film electrode comprises a flexible Zn film electrode.

5. The rechargeable zinc metal battery of claim 3, wherein the Zn film electrode comprises a flexible three-dimensional Zn film electrode.

6. The rechargeable zinc metal battery of claim 3, wherein the Zn film electrode comprises acetylene black used as an electrically conductive network.

7. The rechargeable zinc metal battery of claim 3, wherein the Zn film electrode comprises an ionic liquid based gel polymer used as an ionic conductive binder.

8. The rechargeable zinc metal battery of claim 3, wherein the ionic liquid based gel polymer comprises an ionic liquid (EMIMTFSI)-based gel polymer (PVDF-HFP).

9. The rechargeable zinc metal battery of claim 3, wherein the electrolyte comprises an ionic liquid electrolyte.

10. The rechargeable zinc metal battery of claim 3, further comprising an electrically conductive material, a plurality of metal particles, and an ionic liquid electrolyte.

11. The rechargeable zinc metal battery of claim 3, wherein the ionic liquid based gel polymer comprises a poly(vinylidene fluoride)-co-hexafluoropropylene, the electrically conductive material includes acetylene black, the plurality of metal particles include zinc, and the ionic liquid electrolyte includes a sulfonate salt.

12. A membrane comprising a gel polymer including a fluorinated polyolefin.

13. The membrane of claim 12, wherein the fluorinated polyolefin includes a polyvinylidene fluoride, a polytetrafluoroethylene, a hexafluoropolypropylene, or a combination thereof.

14. The membrane of claim 12, wherein the fluorinated polyolefin is a copolymer of a polyvinylidene fluoride, a polytetrafluoroethylene, a hexafluoropolypropylene, or a combination thereof.

15. The membrane of claim 12, wherein the fluorinated polyolefin is poly(vinylidene fluoride)-co-hexafluoropropylene.

16. The membrane of claim 12, further comprising an electrically conductive material, for example, an electrically conductive network.

17. The membrane of claim 16, wherein the electrically conductive material includes carbon black, carbon nanomaterials, graphene, graphite, a conductive polymer, or acetylene black.

18. The membrane of claim 16, wherein the electrically conductive material is acetylene black.

19. An electrode comprising the membrane of claim 12.

20. The electrode of claim 19, further comprising a plurality of metal particles.

21. The electrode of claim 20, wherein the plurality of metal particles include zinc.

22. The electrode of claim 20, further comprising an ionic liquid electrolyte.

23. The electrode of claim 22, wherein the ionic liquid electrolyte includes an imidazolium sulfonyl imide.

24. The electrode of claim 23, wherein the imidazolium sulfonyl imide includes 1-ethyl-3-methylimidazolium bis(trifluoromethylsulfonyl)imide.

25. A battery comprising the electrode of claim 19 and an electrolyte.

26. The battery of claim 25, wherein the electrolyte includes a sulfonate salt.

27. The battery of claim 25, wherein the electrolyte includes a trifluoromethanesulfonate salt.

28. The battery of claim 25, wherein the electrolyte includes zinc trifluoromethanesulfonate.

29. A method of manufacturing an electrode comprising:
casting a mixture of a gel polymer including a fluorinated polyolefin, an electrically conductive material, and a plurality of metal particles to form a wet film; and
drying the wet film.
